(19) United States
(12) Patent Application Publication
(10) Pub. No.: US 2008/0202430 A1
(43) Pub. Date: Aug. 28, 2008

(54) MILKING STATION AND METHOD FOR MILKING

(75) Inventors: Jelto Christian Harms, Uplengen-Remels (DE); Matthias Ahrens, Lippetal (DE)

Correspondence Address: SEED INTELLECTUAL PROPERTY LAW GROUP PLLC, 701 FIFTH AVE, SUITE 5400, SEATTLE, WA, 98104, US

(73) Assignee: WESTFALIASURGE GMBH, Boenen (DE)

(21) Appl. No.: 12/020,120

(22) Filed: Jan. 25, 2008

Related U.S. Application Data
(63) Continuation-in-part of application No. PCT/EP2006/007528, filed on Jul. 28, 2006.

(30) Foreign Application Priority Data
Jul. 28, 2005 (DE) 10 2005 035 426.2

(51) Int. Cl. A01K 1/01

(52) U.S. Cl. 119/14.02; 119/14.03

(57) ABSTRACT

A milking station and a method of milking for improving hygiene at a milking station, including a device for removing contaminants stuck to the floor of an accommodating area, a device for producing a directed flow of the contaminants provided on the floor. The surface of the milking area is wetted by nozzles integrated in a region of the floor of the milking area before an animal is milked, dirt is washed away from the floor of the milking area after milking, and the floor is then automatically wetted once again.

### BACKGROUND

1. Technical Field

The present disclosure relates to a milking station and to a method for milking and refers, in particular, to measures for improving hygiene at a milking station.

2. Description of the Related Art

A milking station normally has an accommodating area in which the animal that is to be milked is accommodated during the milking. Normally a number of such accommodating areas, in the form of milking areas arranged one behind the other or one beside the other, are formed at the milking station. Separated therefrom, normally by a gate, is, as a rule, a pit in which the user of the milking station is accommodated during the milking.

When entering the milking station, the animals to be milked carry in contaminants that have stuck to their legs, whereby the hygiene at the milking station is spoiled. The animals to be milked also tend to excrete dung or to urinate at the milking station. Accordingly, the milking station must be cleaned of these contaminants at regular intervals.

Today this cleaning is done by hand, for example, with a pressurized steam cleaner guided by hand. This activity is time-consuming and reduces the efficiency of the milker with respect to his or her actual job. Furthermore, it can happen that when the milking station is used for a longer time and no cleaning is carried out during this time, the contamination can dry on, as a result of which additional time and also cleaning agent, as a rule, water, are required in order to remove the contamination.

The dung grids generally known for animal husbandry that can form the walking surface of a milking station and through which dirt can fall, have not proven satisfactory due to the hygiene standards that are to be met at the milking station. The problems described in the preceding regarding the removal of dung and other contaminants, coupled with a certain time pressure placed on the user of the system, furthermore lead to the fact that now and then the contamination is not removed completely, which leads to quality problems in the milk removed from the animals, because bacteria and other pathogens can collect on the floor of the milking station. Particularly problematic in this respect are butyric acid pathogens that are excreted with the dung and that have a substantial influence on the milk quality. The milk quality is also evaluated in this respect by the dairies at the time of delivery, and an elevated content of butyric acid bacteria leads to a reduction in the price paid per liter.

There are already suggestions for improving the hygiene conditions in the area of the stall that are known in the case of animals that are kept in barns. For example, DE 102 57 286 proposes a fluoride floor for animal husbandry with a mucking-out system in which the fluoride floor has an essentially closed surface and the mucking out system has at least one mucking out slide that lies on the fluoride floor and that can be moved back and forth upon this floor. Furthermore, a watering system for wetting the fluoride floor surface is provided, the watering system being integrated in the floor. This proposal is intended to prevent the dung and contamination from drying on to the floor. The system is not suitable for milking stations, firstly because the animals cannot dodge the mucking-out slide that can be moved back and forth, and additionally because the slide needs guide grooves cut into the floor for guidance. Such grooves are undesirable in view of the hygiene requirements that are to be met at a milking station. Furthermore, the slide cannot transport the contamination and, particularly, the dung and bacteria, away to such a degree as would be required at a milking station. In addition, the watering system must be complexly laid with many pipes and nozzles in order to achieve the most uniform output of water possible.

In JP-2003199452A, a further development of a slotted floor is known in which the floor has a two-part configuration, with a first upper layer that forms the lying surface for the animal, whereby the first layer can be raised away from a lower layer that allows dung and urine through. Raising the floor is intended to clean the area between the first and second layer and further the removal of dirt and dung. Such a system is particularly not suitable when there is a load on the floor at certain points due to the feet of the animal to be milked at a milking station. Furthermore, there are the problems already discussed in the preceding that fundamentally accompany slotted floors with dung grids.

In order to keep the contaminants from sticking to the floor of the accommodating area, it is known from DE 29 28 930 to apply a liquid film to the floor for the time during which the animal to be milked is accommodated. Sprayer nozzles are provided above the floor for this purpose, whereby the liquid issues from these nozzles. The known milking station has lines laid above a milker pit, through which lines the liquid is conveyed to the sprayer nozzles, which then direct a stream of liquid at the area accommodating the hindquarters of the animal. The liquid film produced in this way runs across the slanted floor towards a drain system. Dirt and contaminants cannot be reliably prevented from sticking to this known device. Furthermore, the method leads to considerable agitation in the animal standing at the milking station, because the stream of liquid is applied during the milking and temporally produced next to the animal. The same can be said for the solution proposed by EP 0 398 013.

A milking station with a spray head is known from DE-U-67 52 792, whereby the spray head is provided on the floor in the area of the hind legs of the animal and under the udder of the animal to be milked. This spray head is activated before the attachment, in order to direct a drizzle with a disinfection liquid at the udder of the animal to be milked. Accordingly, the device known from this state of the art is not suitable for cleaning the floor of contaminants, particularly in the case of contamination due to the excretion of dung. These contaminants are normally found at a point on the floor located at the rear, i.e., behind the hind legs of the animal to be milked.

### BRIEF SUMMARY

The present disclosure is directed to a milking station and a method for milking by means of which the hygiene conditions at the milking station can be improved.

To solve the problem with respect to the device, the present disclosure provides a milking station that differs from the generally known milking stations in that means for removing contaminants stuck to the floor and means for producing a directed flow of the contaminants on the floor are assigned to the floor of the area accommodating the animal to be milked. To be seen as the means for removing the contaminants are such means that lift contaminants lying on the floor up from the floor from underneath, i.e., that move them in a direction essentially at a right-angle to the floor surface. This means can be a hydraulic, mechanical or pneumatic means. In particular, the means serves to at least partially loosen the contaminants stuck from the floor, namely at least in that area of the floor particularly contaminated by the excreted dung, said area normally being located behind the hind legs of the animal to be milked when it is accommodated at the milking station. Furthermore, the milking station according to the disclosure comprises a means for producing a directed flow on the floor. This means produces a flow essentially parallel to the surface of the floor and transports the contaminants on the surface by means of a directed flow. The directed flow can also promote or contribute to the loosening of the contaminants from the floor surface.

According to a preferred further development of the present disclosure, in which the milking station is formed with a pit for a user or a robotic milking machine or both, and the accommodating area for the animal to be milked lies at a higher level than this pit, the means for producing a directed flow is located at the pit-side edge of the floor. In the case of this expedient further development, the contaminants are removed away from the user or robot. The means for producing a directed flow is preferably formed by a liquid nozzle that is directed towards the floor of the accommodating area. This nozzle is more preferably formed as an integral part of the so-called pit edge. The pit edge is a prefabricated component that is normally supplied with the milking station by the milking station manufacturer and that is built in, in particular, cast into concrete, during the on-site installation of a milking station. The pit edge normally protrudes over the floor of the accommodating area with a side piece going off diagonally in the direction of the pit This side piece is particularly suitable for arranging the previously mentioned liquid nozzles, and on which clamping and holding elements for guiding and attaching the parts of the teat cup cluster are regularly arranged, whereby these elements can be reached by the milker, because the pit edge borders the pit-side edge of the accommodating area.

To concentrate the contaminants on the floor of the accommodating area and remove the contaminants, a drain groove for conducting the contaminants is proposed on the milking station by a further preferred development. This is preferably located on the side of the milking station lying opposite the means for producing a directed flow. A deflector element is preferably arranged directly adjacent to the drain groove, on the side lying opposite the means for producing a directed flow. This deflector element protrudes beyond the drain groove and serves to prevent the directed flow from overshooting the groove. This deflector element is preferably formed by the outer side wall of the milking stand, the outer side wall bordering the accommodating area.

For further development of the means for removing the contaminants stuck to the floor, outlet openings for a cleaning liquid that issues under pressure from the floor are preferably provided. These outlet openings are, however, preferably not formed in such a manner that they are uniformly distributed across the floor of the accommodating area. According to a preferred further development of the present disclosure, it is instead proposed that the outlet openings be provided at least in sections across the entire surface, namely, particularly in the area of the hind legs of the animals to be milked when the animals are in their milking position. If a number of milking positions are provided at the accommodating area, a corresponding area with outlet openings across the entire area is to be provided for each of the milking positions. The concentration of the outlet openings in the area of the hind legs of the animals to be milked makes possible good removal of the contaminants that arise during the excretion of dung.

The previously mentioned outlet openings are connected to a pressure source for the cleaning or disinfection liquid that issues from the floor. The removal of the contaminants subsequently occurs through the outlet openings. Furthermore, the floor can be disinfected after the removal of the contaminants. The outlet openings are preferably provided in such a way that after the milking of a specific animal at the milking station and before the arrival of the next animal to be milked at the milking station, a disinfection film is applied to the floor, so that transfer of germs, which can be contained in the dung, urine or milk of the previous animal, to the subsequent animal is avoided. This measure makes it possible to milk each individual animal at a clean and disinfected milking station, as a result of which the hygiene requirements to be placed on the herd are allowed for in an improved manner.

The previously mentioned outlet openings that are provided in the floor can preferably optionally be connected to a reservoir for cleaning liquid, for example, water at water-line pressure, and a reservoir for disinfection liquid. Consequently, corresponding supply lines can be provided below the floor, whereby it is possible to connect said lines to the outlet openings via a switchable valve. The valve is preferably controlled via a control system of the milking station, whereby the control can, for example, take place dependent on activations of the teat cup cluster or opening or closing functions of entrances to the milking station. With a view to milking that is as free of stress as possible, it is preferable to start the cleaning only after the previous animal has left and to end the disinfection before the next animal has entered the milking station.

The previously mentioned pressure source for disinfection and cleaning liquids and the outlet openings are preferably coordinated to one another in such a way that when the pressure source is activated, the cleaning liquid issues from the outlet openings essentially without spraying up from the floor. The purpose of this preferred development is to see to it that the cleaning liquid issues from the floor in a manner that is essentially in the form of a film, namely perpendicularly to the surface of the floor, without, however, the spraying causing the contaminants to be distributed or sprayed in an uncontrolled manner in the area of the milking station. For this purpose, the surface of the floor is preferably formed from a porous material that forms micro-channels in the upper floor surface. To be considered as micro-channels in the sense of the present disclosure are particularly such flow outlets that have an effective cross-section of 10 μm to 1,500 μm. These can particularly be created in a simple and economic manner and such that they are uniformly distributed across a large surface by means of having the porous material be a sintered material. It has been seen that not only a sintered material is suitable as a porous material, but that also plastic as a sintered material satisfies the practical requirements and, in particular, stands up to the mechanical loads caused by the animals to be milked. The micro-channels of the upper floor layer communicate with at least one supply line that is integrated into the floor. This is preferably cast in at the time of the pouring of the platform forming the accommodating area.

To prevent the cleaning liquid from seeping into the floor and, not least, out of consideration for the hygiene requirements, according to a preferred further development it is proposed that the porous surface of the floor be applied to an intermediate layer that is impervious to water. A non-specific material, such as concrete, for example, that serves only to build up the milking station of the platform, is located only underneath the intermediate layer.

The porous structure that is described in the preceding and that preferably forms the outlet openings is provided distributed across the entire surface of the accommodating area in a preferred further development of the present disclosure. Regardless of this, in the area of the hind legs of the animals to be milked, it is possible to provide additional outlet openings, i.e., a porosity with a greater number of micro-channels. Furthermore, at these points special means can be worked into the surface, the means allowing effective cleaning and removal of dung. For example, particularly at these points, sensors for recording the contamination of the floor can be integrated, said sensors, for example, determining the presence of dung by means of heat sensors or optic sensors and passing corresponding signals on to a control device that controls the cleaning process in a suitable manner. Included here are, in particular, cleaning strokes through the outlet openings of the floor directly after detection of contamination, with simultaneous activation of the means for forming a directed flow of the contaminants on the floor for the removal of the same. As far as a high density of outlet openings is to be provided in the area of the hind legs of the animal to be milked at the milking station, this development can be realized by means of providing an increased number of micro-channels. Alternatively, in one area of a uniform density of micro-channels, separate nozzles can also be let in, whereby it is possible to activate the nozzles separately via separate supply lines and, in particular whereby the nozzles are separately activated by a signal from the previously mentioned sensor when the presence of dung has been detected.

The control can be on-request control, i.e., it can be activated depending on the degree of contamination in the accommodating area. The control can furthermore activate the means for removing the contaminants stuck to the floor or the means for producing the directed flow in certain phases of a milking pass of an animal to be milked. Understood here as a milking pass is an interval of time which elapses between the entry into and exit from the milking station by a certain animal. The various phases of this interval, for example, the opening of gates and the arrival of an animal at the milking station, are today routinely automatically recorded and entered into a system for herd management. Such a system is able to identify the animals and to control the quantity of milk removed from a certain animal and the quantity of feed given to an animal during milking. The corresponding signals of the herd management system can likewise be used for phase-precise cleaning of the accommodating area. For example, the cleaning should already be started when the animals leave the milking area, i.e., for example, a signal that indicates that the gate has been opened is recorded by the herd management system.

Furthermore, after the animal has been recognized by the herd management system, information specific to an animal can be used in order to control the cleaning process of the special milking area of this one animal. The previously mentioned sensors can, for example, have determined the increased dung excretion frequency of a certain animal in previous milking passes and, as a result, the cleaning frequency at this special milking area is automatically adjusted by the control system. If it has been determined that certain animals routinely do not excrete dung at the milking station, it is possible, for example, to do without a cleaning step when the animals change at the milking station. Normally, control of the cleaning process is started when the animal leaves the milking station. In groups of animals that are milked at essentially the same time, the cleaning is preferably done when the group as a whole has left the accommodating area.

By means of precisely controlling the cleaning process, cleaning agent, especially water and, possibly, cleaning additives added thereto, can be saved. For this purpose, the control system can control the liquid pressure of the agent and the composition, i.e., the proportion of cleaning additive.

In order to clean the accommodating area in a manner that conserves resources as best as possible and to solve the problem related to the method, the present disclosure proposes a method for milking at a milking station with at least one milking area to be entered by the animal to be milked, which method according to the disclosure differs from the known methods in that before the milking of the animal, the surface of the milking area is wetted by means integrated in the area of the floor of the milking area and in that after the milking, contaminants on the floor of the milking area are washed away and then the floor is wetted again. As a result of the cyclic wetting of the surface of the milking area with each milking pass, a liquid film is formed on the surface of the film before the entry of the contaminants, said film assisting in the later rinsing away of the contaminants. By having the method proceed in this way, a relatively small use of rinsing liquid can result in a complete and thorough cleaning after each milking pass.

To avoid bacteria and germs that can be contained in the milk, the dung or the urine of an animal that is to be milked from being carried along, according to an alternative development of the method according to the disclosure it is proposed that the milking area be disinfected before each arrival of an animal to be milked at this milking area, namely, preferably by the formation of a disinfection film over outlet openings that are provided in the floor of the milking station, each at that location at which the cited germ carriers normally appear while the animal is accommodated. The cleaning and disinfection can, for example, take place at the end of the milking process, when the animal to be milked is still to be found in the milking station, whereby the cleaning and disinfection process can be kept up until such a time as the previous animal has left the corresponding milking station, so that this milking station is clean and disinfected when the next animal to be milked arrives.

The previously mentioned floor of the milking station with a layer that has a number of micro-channels and that forms the walking surface, as well as the supply lines for the cleaning liquid assigned to these micro-channels, is in itself essential to the disclosure.

### BRIEF DESCRIPTION OF THE SEVERAL VIEWS OF THE DRAWINGS

Further details, advantages and characteristics of the present disclosure result from the following description of an embodiment, in conjunction with the accompanying drawings, in which:

FIG. 1 schematically shows a perspective view of an embodiment of the present disclosure;

FIG. 2 is an enlarged view of a detail drawn into FIG. 1; and

FIG. 3 is an embodiment drawn in FIG. 1 during removal of the contaminants.

### DETAILED DESCRIPTION

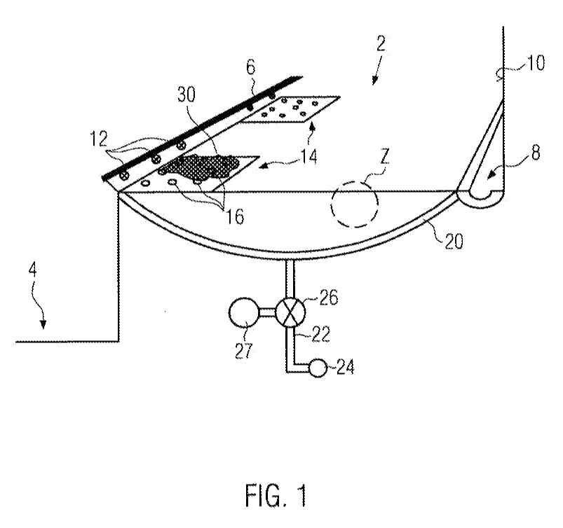

FIG. 1 shows the fundamental components of a milking station with an accommodating area 2 for the animals to be milked and a pit 4, lying deeper than the accommodating area 2, for accommodating a milker. On the long pit-side side of the accommodating area 2, a pit edge 6 is provided that protrudes beyond the floor of the accommodating area 2 and goes off outwards towards the pit 4 diagonally. On the opposite side of the pit edge 6 and flush with the surface of the accommodating area 2, a drain groove 8 is provided that is located directly adjacent to a side wall 10 of the milking station.

The pit edge 6 has a number of fields of injection nozzles 12. Each of the fields of injection nozzles 12 corresponds to a milking area for an animal to be milked. Furthermore, corresponding to the number of milking areas, directly adjacent to the injection nozzles 12, a nozzle floor 14 is let flush into the floor of the accommodating area 2, the nozzle floor 14 includes a multitude of outlet openings 16, which are fundamentally arranged across the entire surface of the nozzle floor 14.

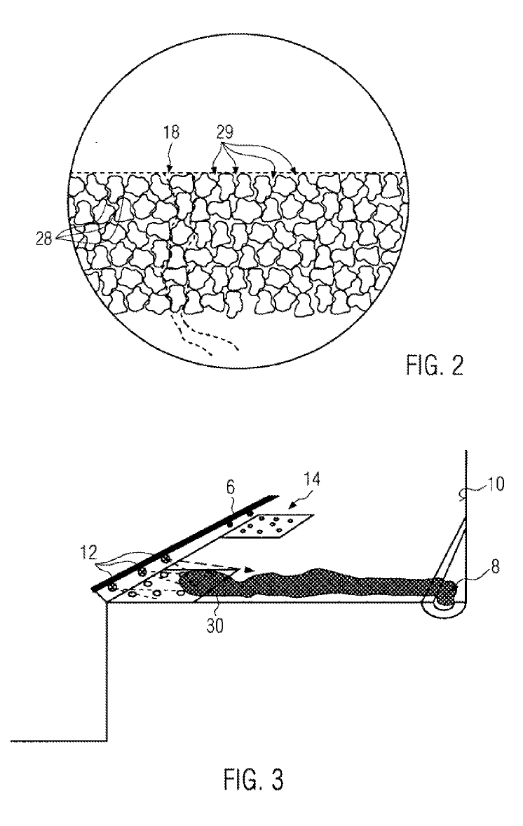

As can be seen in FIG. 2, which is an enlarged representation of area 2 shown in FIG. 1, the remaining floor of the accommodating area 2 is formed by a porous layer 18 that is made of sintered plastic grains. The porous layer lies on a layer 20 that is impervious to water, for example, a bitumen layer, to which a connection line 22 for a water supply line 24 is connected. In the supply line 22, a controllable valve 26 is provided, by means of which water that is pressurized can be fed into the porous layer 18 from the water supply line 24 in a controlled manner. The pressure ratios are coordinated to one another here in such a way that the water is conveyed through micro-channels 28 formed in the porous layer 18, the water streaming out of the outlet openings 29 of the porous layer 18, without spraying away from this layer.

The nozzle floor 14 is located in an area of the hind legs of the animal to be milked, and FIG. 1 schematically shows dung 30 that gathers on the nozzle plate 14 while the animal is being milked at the milking station. At the end of the milking cycle, for example, when a drying up of the milk flow is detected, and when the animal is accommodated at the milking station, the nozzles 12 and the nozzles of the nozzle floor 14 are activated. The dung 30 floats up and is rinsed away by the nozzles 12 that are pointed essentially parallel to the surface of the floor towards the drain groove 8. From there, the contaminants and the rinse water reach a collection container (not shown), the contents of which can occasionally be fed to a water treatment system, in the framework of which the contaminated water is filtered and the contaminants are separated. The water can subsequently be reused for cleaning.

This cleaning step is kept up until the animal to be milked has left the milking station after a gate has been opened. The valve 26 is subsequently set and connected to a pressurized reservoir 27 for disinfection liquid, so that disinfection liquid can issue from the discharge openings 16 and form a disinfection film on the surface of the floor.

The various embodiments described above can be combined to provide further embodiments. All of the U.S. patents, U.S. patent application publications, U.S. patent applications, foreign patents, foreign patent applications and non-patent publications referred to in this specification and/or listed in the Application Data Sheet, are incorporated herein by reference, in their entirety. Aspects of the embodiments can be modified, if necessary to employ concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A milking station having a floor with an accommodating area for at least one animal to be milked and a user, comprising:
means for removing contaminants stuck to the floor and means for producing a directed flow of the contaminants on the floor, the directed flow producing means arranged on the floor of the accommodating area.

2. The milking station of claim 1, comprising a pit for the user or a robotic milking machine or both, said milking pit lying lower than the accommodating area, and wherein the means for producing a directed flow is arranged on a pit-side edge of the floor.

3. The milking station according to claim 2 wherein the means for producing a directed flow comprises at least one liquid nozzle, that is directed at the floor of the accommodating area and which produces a stream of liquid directed away from the pit.

4. The milking station according to claim 1, comprising a drain groove for conducting the contaminants away from the pit and the accommodating area.

5. The milking station according to claim 4 wherein the drain groove is provided on a long side of the accommodating area that lies opposite the means for producing a directed flow, the milking station further comprising a deflector element arranged directly adjacent the drain groove.

6. The milking station according to claim 1, comprising outlet openings provided in the floor for dispensing cleaning or disinfection liquid or both issued under pressure.

7. The milking station according to claim 6 wherein the outlet openings can optionally be connected to a reservoir for cleaning liquid or a reservoir for disinfection liquid or both.

8. The milking station according to claim 7 wherein the outlet openings and the pressure source for the cleaning liquid that issues from the floor are adapted to issue the cleaning liquid from the outlet openings without spraying up off of the floor.

9. The milking station according to claim 7 wherein at least one supply line for the cleaning liquid is arranged in the floor and wherein the surface of the floor is, in any case, partially formed by a porous material.

10. The milking station according to claim 9 wherein the porous material is a sintered material.

11. The milking station according to claim 10 wherein the sintered material is a plastic.

12. The milking station according to claim 9 wherein the sintered material is a sintered metal.

13. The milking station according to claim 10 wherein the porous surface of the floor is placed on an intermediate layer that is impervious to water.

14. The milking station according to claim 9 wherein the entire surface of the accommodating area is formed such as to be porous.

15. The milking station according to claim 14, comprising a high density of outlet openings in the area of the accommodating area where hind legs of an animal are located during milking.

16. The milking station according to claim 15 wherein the means for producing a directed flow is predominantly directed at a surface area having a high density of outlet openings.

17. The milking station according to claim 1, comprising sensors for detecting contamination on the floor.

18. The milking station according to claim 17, comprising a controller for activating the means for removing contaminants stuck to the floor and the means for producing the directed flow in accordance with certain phases of a milking pass of an animal to be milked.

19. The milking station according to claim 18 where the controller is configured to selectively activate the means for removing contaminants and the means for producing the directed flow on the basis of information specific to an animal.

20. The milking station according to claim 19 wherein the controller controls a pressure of the liquid means or a composition of the liquid or both.

21. The milking station according to claim 17 wherein a duration of the flow can be adjusted in response to the sensors that detect the contamination of the floor.

22. A method for milking at a milking station with at least one milking area to be entered by the animal to be milked, comprising: before the milking of the animal, the surface of the milking area is wetted by a means integrated into the floor of the milking area; and after the milking, contaminants on the floor of the milking area are rinsed away, and, the floor is subsequently wetted again.

23. The method according to claim 22 wherein the means for wetting the floor and the means for rinsing away the contaminants are controlled on the basis of information specific to the animal.

24. The method according to claim 23, wherein each milking area is disinfected before the arrival of an animal to be milked at this milking area.

25. The method according to claim 23 wherein the milking area is extensively wetted or disinfected through means integrated in the area of the floor of the milking area.

26. The method according to claim 23 wherein before the arrival of the animal to be milked at the milking area, a disinfection film is applied to the floor.

27. The method according to claim 23 wherein the means for wetting the floor with cleaning or disinfection liquid and the means for rinsing away the contaminants are controlled on the basis of information specific to the animal.

28. A floor for a milking station, comprising an upper layer that forms the walking surface having a multitude of micro-channels, and a deeper-lying supply line for cleaning liquid is connected to the micro-channels.
